(19) United States
(12) Patent Application Publication
(10) Pub. No.: US 2018/0003440 A1
(43) Pub. Date: Jan. 4, 2018

(54) LINTEL SHELF COOLERS IN VERTICALLY ORIENTED FURNACES

(71) Applicant: Allan J. MacRae, Hayward, CA (US)

(72) Inventor: Allan J. MacRae, Hayward, CA (US)

(21) Appl. No.: 15/705,152

(22) Filed: Sep. 14, 2017

Related U.S. Application Data
(60) Provisional application No. 62/554,588, filed on Sep. 6, 2017.

(51) Int. Cl. F27D 1/00; F27B 1/24; C22B 5/12

(52) U.S. Cl. CPC F27D 1/004; C22B 5/12; F27B 1/24

(57) ABSTRACT

Improved vertically orientated metal smelting or converting furnaces, in which at least a portion of its steel shelled vessel is cylindrical. At least one ringed row of horizontal coolers are fixed to the steel vessel shoulder-to-shoulder to form a lintel shelf that cantilevers inward. Such lintel shelf is above the bath zone of the furnace and fully supports a refractory brick lining and interdigitated horizontal coolers above. Below, in the bath zone, the weight of another lining of refractory brick is supported by the floor and the outside of the lining bears against several vertical bathline coolers. The advantage of the improvements include relieving the weight of the upper refractory brick lining and horizontal coolers from the lower bathline lining of refractory brick. Without having to bear such weight, the lower bathline lining of refractory brick can be safely allowed to corrode and thin beyond conventional minimums.

### FIELD OF INVENTION

The present invention relates to improved vertically orientated metal smelting or converting furnaces with cylindrical refractory brick linings. And more specifically to improved furnaces that separately and fully support the refractory brick linings above the bath zone with at least one horizontal cooler lintel shelf fixed externally to the cylindrical steel vessel.

### BACKGROUND

AUSMELT®/ISASMELT™ non-ferrous smelters drop moist solid feeds from above into a tall cylindrical furnace with a matte/metal/slag bath while also blowing oxygen-enriched air down in through a submerged vertical lance. (AUSMELT® of Outotec, and ISASMELT™ of Glencore Technology.) Once fully melted, the matte/slag is periodically tapped into a setting furnace for separation. These are often referred to as Top Submerged Lance (TSL) furnaces.

The AUSMELT top submerged lance technology optimizes feed material dissolution, energy transfer, reaction, primary combustion, and other critical processes which all take place in the slag layer inside the smelter vessel. Submerging the gas injection ensures that reactions occur rapidly and residence times will be low due to an intense agitation that is caused in the vessel. The degree of oxidation and reduction can be controlled by adjusting the fuel:oxygen ratio supplied to the lance, and the proportion of reductant coal to feed. This easy way to control the oxidation and reduction enables the furnace to be selectively operated between strongly oxidizing through strongly reducing conditions. Operating temperatures in AUSMELT top submerged lance furnaces can range from 900° C. to 1400° C.

ISASMELT furnaces are top-entry submerged-lance upright-cylindrical shaped steel vessels that are lined with refractory bricks. Inside at the bottom of the furnace, in the “liquid zone”, is a molten bath of slag, matte, or metal. A hollow steel lance is lowered into the bath through a hole in the roof of the furnace, and air or oxygen-enriched air is forcefully injected through the lance to agitate the bath.

Mineral concentrates and other materials are dropped into the bath from above through a hole in the roof. If suitably fine, such materials can also be injected down the lance with the air. An intense reaction results in a small volume when the feed materials contact, heat, and react with the oxygen in the injected gas.

Lances may include “swirlers” that force the injected gas to vortex against the walls inside to more effectively cool the lance's walls. Outside of the lance, a layer of slag will freeze on the air-cooled walls. Such frozen slag helps isolate the steel lance from the surrounding temperatures which could be high enough to melt the lance if contacted directly. But ultimately the steel tip of all submerged lances will wear out from the immediately surrounding violence and need replacement. The good news is worn lances are easily refurbished and replaced. The worn tips are simply cut off and new tips are welded onto the original lance body.

ISASMELT furnaces typically operate in the range of 1000-1200° C., depending on their application. The refractory bricks that line the inside floors and walls of the furnaces are there to protect the steel shell from heat inside the furnace that would otherwise melt the steel shell. The refractory bricks are subject to corrosion, wear, uneven heating, swelling with ingrained melt, and fractures because they are brittle. The refractory bricks in the liquid bath zone are especially subject to corrosion and thinning.

Smelted products are removed from furnaces through tap holes in a procedure called “tapping”. Such tapping can be continuous, or done in batches. At the end of a tap, the tap holes can be closed by blocking them with clay plugs. They can be reopened by thermic lances and/or by drilling. Alternatively, the melt can be removed from the furnace using either an underflow or an overflow weir for continuous discharge of molten material.

The smelted products thus tapped will separate on their own once they arrive and settle in a rotary holding furnace, an electric furnace, a settling vessel, a melt-transporting ladle, or granulated.

Most of the large amount of energy needed for smelting that is used to heat and melt sulfide concentrates and feed materials is a product of the reaction of oxygen with sulfur and iron in the concentrates. A small amount of supplemental energy that is needed to balance out losses is supplied by injecting coal, coke, petroleum coke, oil, or natural gas to react with the injected air. Solid fuels are best added through the top of the furnace along with the feed materials, and liquid and gas fuels can be injected with the air forced down inside the lance.

[symbol]

### SUMMARY

Briefly, embodiments of the present invention improve the campaign lives of vertically orientated metal smelting or converting furnaces in which at least a portion of its steel shelled vessel is cylindrical. At least one ringed row of horizontal coolers are fixed to the steel vessel shoulder-to-shoulder to form a lintel shelf that cantilevers inward above the liquid bath zone in the furnace. Such placement of the lintel shelf above the liquid bath zone means the refractory brick lining and interdigitated horizontal coolers above will be fully supported and independent of the refractory brick lining below in the bath zone. The refractory brick lining in the bath zone is itself supported by the floor at the bottom, and bears against several vertical bathline coolers. The improvements relieve the weight of the upper refractory brick lining and horizontal coolers from the shoulders of the refractory brick lining in the bath zone below. Then, without having to bear such traditional weight, the refractory brick lining in the bath zone can be safely allowed to corrode and thin beyond conventional minimums over its extended campaign life.

### SUMMARY OF THE DRAWINGS

FIG. 1 is a cross sectional view diagram of a vertically orientated metal smelting or converting furnace embodiment of the present invention in which at least a portion of its steel shelled vessel is cylindrical;

FIG. 2A is an isometric projection diagram of an improved AUSMELT furnace embodiment of the present invention;

FIGS. 2B and 2C are front and side view diagrams of the vertically orientated metal smelting furnace of FIG. 2A. FIG. 2C includes a side view outline for an ISASMELT furnace;

FIGS. 3A and 3B are side view diagrams of the horizontal lintel coolers typical of vertically orientated metal smelting furnace embodiments of the present invention and similar to that of FIGS. 1, 2A-2C. In particular are shown the details of the mechanical fastening and fixing of the individual lintel coolers externally through shell cutouts to a steel horizontal rib ring of the vessel with large machine bolts;

FIG. 4 is a plan view diagram of a ring row of lintel coolers as included in the vertically orientated metal smelting or converting furnace embodiments of the present invention above;

FIGS. 5A-5C are plan view diagrams of individual lintel coolers that make up the ring row of lintel coolers of FIG. 4; and

FIG. 5D is a side view diagram of the hot face of the lintel coolers of FIGS. 5A-5C looking from inside a furnace. A V-slot forms between the lintel coolers by beveling back the adjacent and parallel sides of each cooler; and

FIG. 6 is a plan view diagram of a ring row of lintel coolers with a splash block as included in the vertically orientated metal smelting or converting furnace embodiments of the present invention as in FIGS. 2A-2C.

### DETAILED DESCRIPTION OF THE EMBODIMENTS

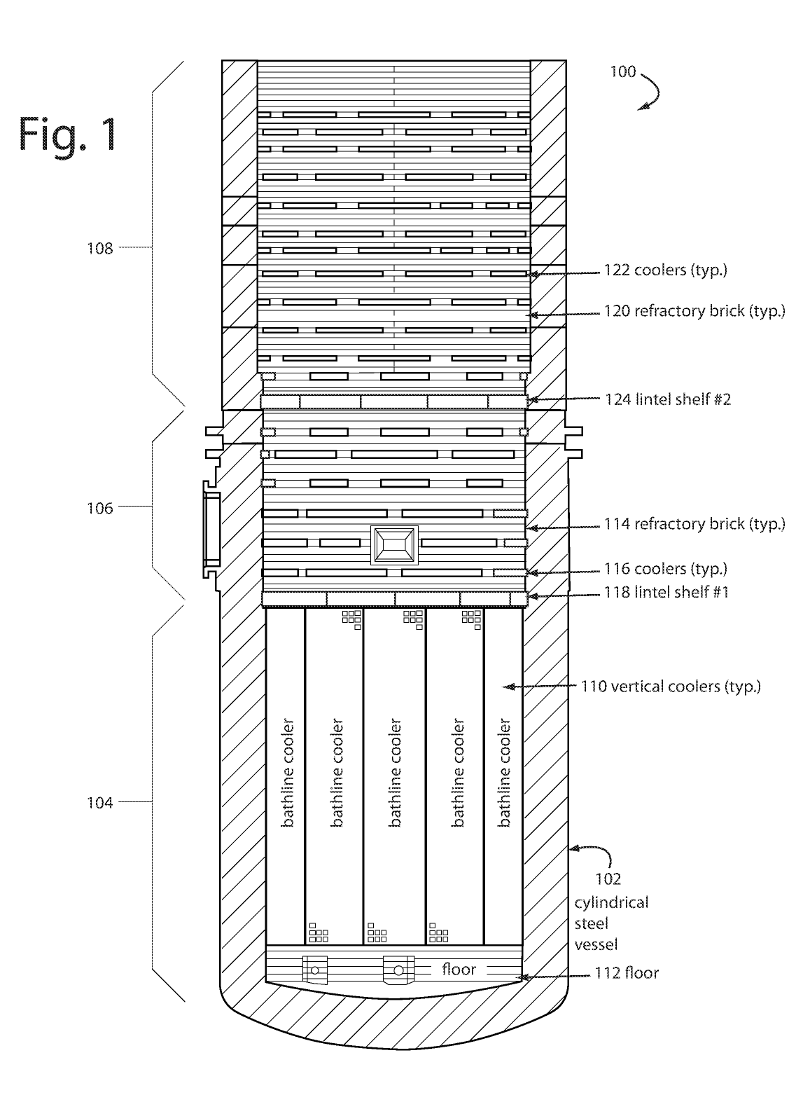

FIG. 1 represents a vertically orientated metal smelting or converting furnace 100 in which at least a portion of its steel shelled vessel 102 is cylindrical. Furnace 100 is fully lined inside with a refractory brick lining that is divided and separated into three vertical sections, partitions 104, 106, and 108.

The three vertical sections of refractory brick lining respectively in each partition 104, 106, and 108 do not weigh on any other. The bottom section of refractory brick lining (partition 104) is conventionally supported by the floor. The upper sections of refractory brick lining (partitions 106 and 108), above the bath zone, are unconventionally supported by horizontal cooler lintel shelves solidly attached externally to the steel shelled vessel 102. This leads to a major advantage of embodiments of the present invention in that the bottom section of refractory brick lining in the bath zone can be allowed to corrode and thin beyond conventional minimums because it doesn't have to support all the weight above. Thus extending the useful campaign life and even increasing the bath volume.

The refractory brick (not shown here for clarity of the other components) of partition 104 contains a liquid bath of slag, matte, and/or metal. Such liquid bath is highly corrosive to refractory brick and will thin the brick over time. Such thinning will eventually compromise the ability of the refractory brick lining to support the weigh of more elevated sections of refractory brick lining.

Behind the refractory brick lining within partition 104, and floated inside steel vessel 102, there are several vertical bathline coolers 110 in one or more rings. The hot faces of these are textured, pocketed, or grooved to promote and improve the attachment and retention of the refractory brick with cements and mortars. The full weight of the refractory brick lining within partition 104 an the vertical bathline coolers they are supported by a floor 112.

Above this, within partition 106, several horizontal layers of a refractory brick 114 are set in rows and interdigitated with respective liquid-cooled horizontal coolers 116. The full weight of refractory brick 114 and coolers 116 is supported by a first cantilevered lintel shelf of liquid coolers 118. An intermediate metal plate inside the vessel may be included to help support the refractory brick lining in the event of a loss of liquid cooling. The lintel shelf 118 is bolted and fixed outside to steel vessel 102. None of such weight bears on the refractory brick lining of partition 104 below. An alternative arrangement is to extend partition 104 to the underside of partition 108, thus eliminating partition 106.

And above this, in partition 108, several more horizontal layers of a refractory brick 120 are set in rows and interdigitated with respective liquid-cooled horizontal coolers 122. A second cantilevered lintel shelf of liquid coolers 124 is fixed to the wall of steel vessel 102 and supports the full weight of the refractory brick 120 and coolers 122 within partition 108. None of such weight bears on any of the refractory brick linings of partitions 104 and 106 below.

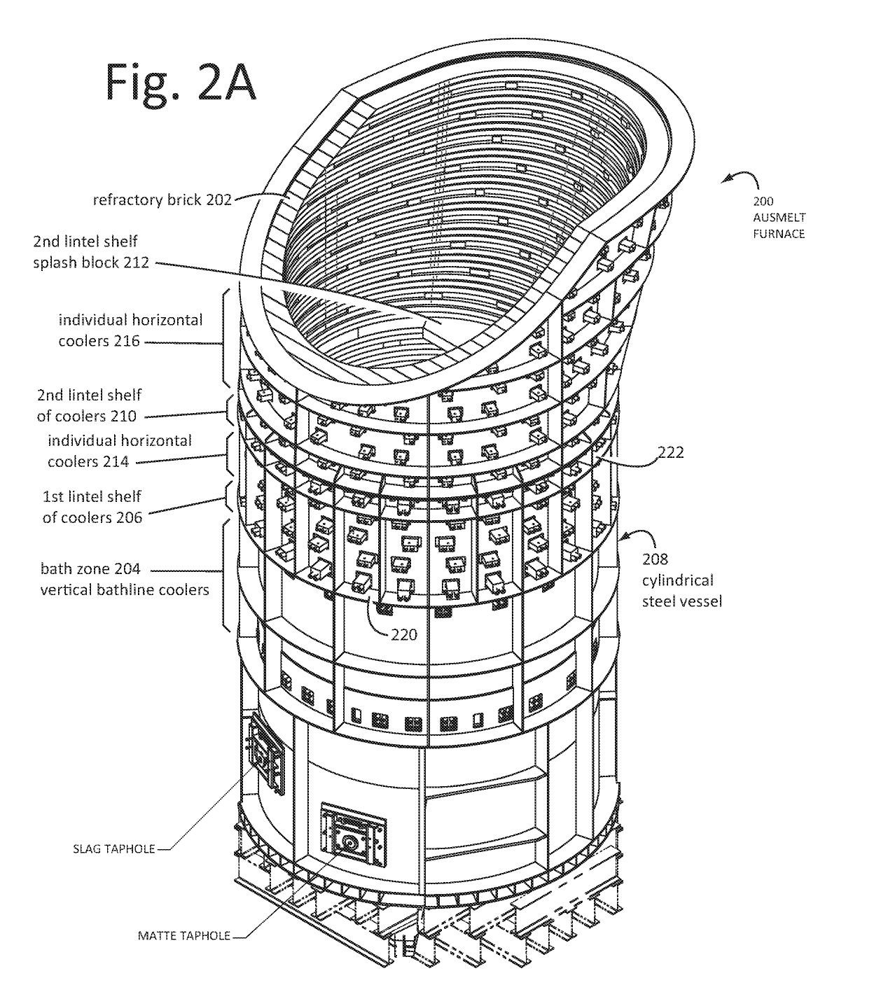

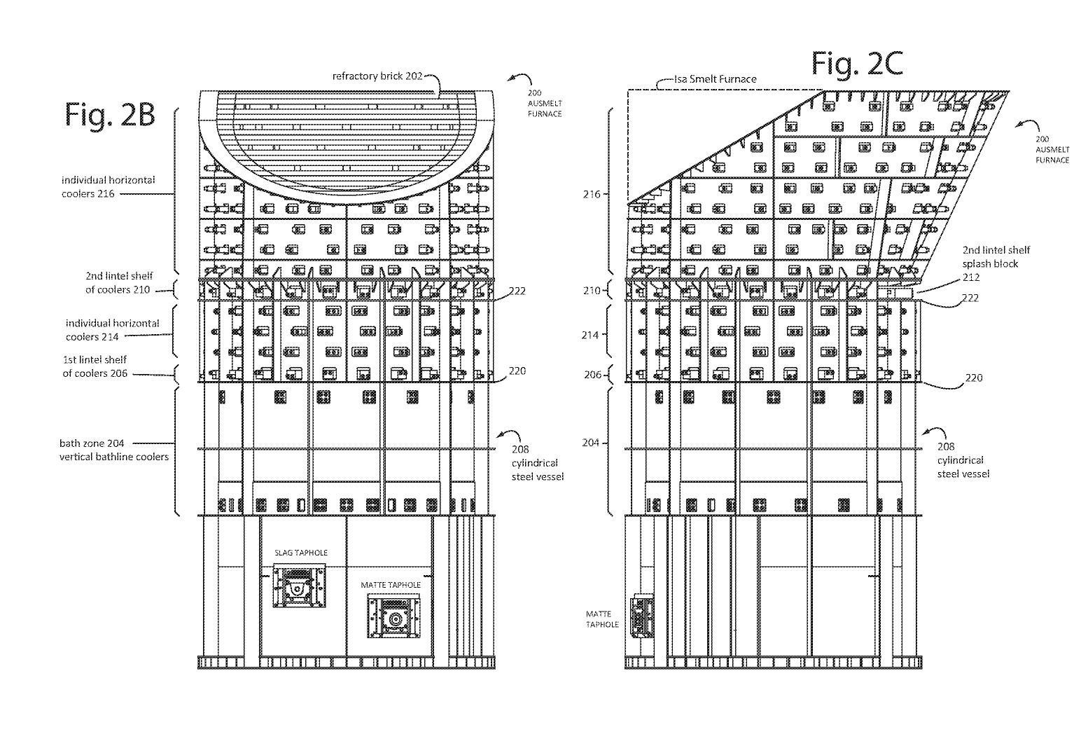

Over the campaign life of furnaces like furnaces 100 (FIGS. 1) and 200 (FIGS. 2A-2C), there will be a gradual upward expansion and growth of the refractory brick linings 202 in each of the three partitions 104, 108, and 108 divided by the first and second lintel shelves of coolers 206 and 210.

Such expansion and growth of the refractory brick linings creates challenges in keeping the areas just under each lintel shelf of coolers 206 and/or 210 sealed. Hot process gases must not be allowed to find and escape through cracks and fractures in the refractory. So any seals must accommodate the expansion and growth of the refractory brick linings.

Embodiments of the present therefore include at least a vertical slip joint or a compressible refractory material to seal the areas just under the lintel shelf of coolers 206 and/or 210.

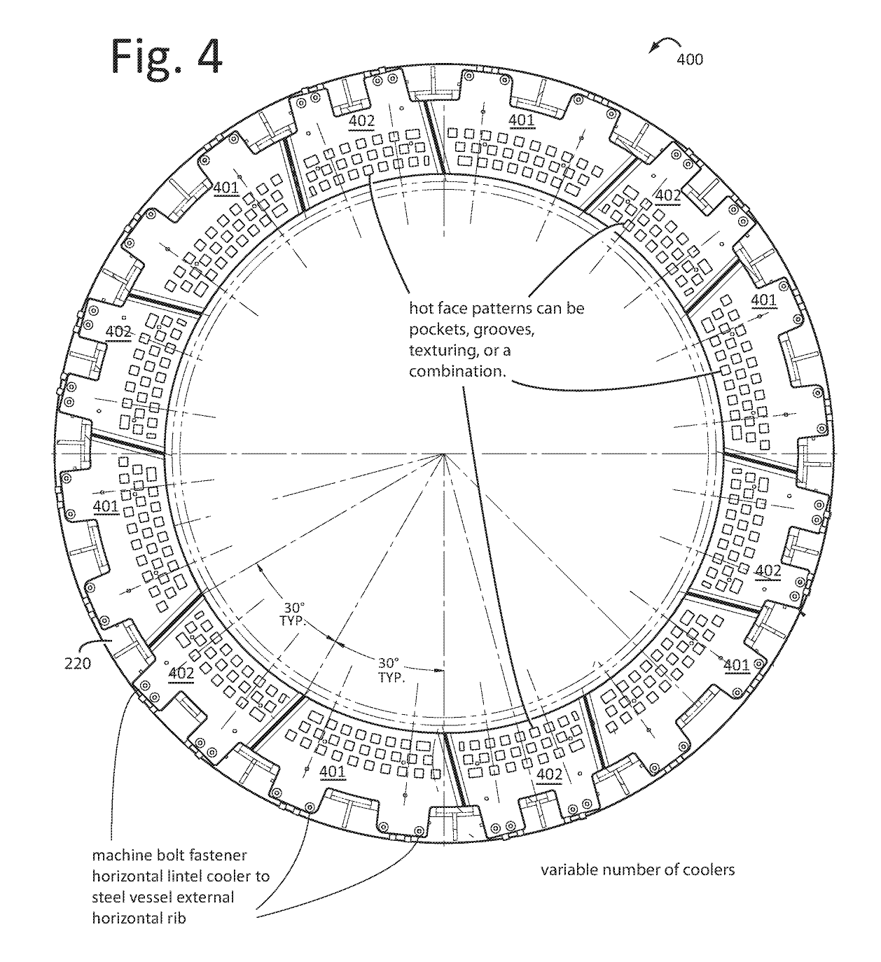

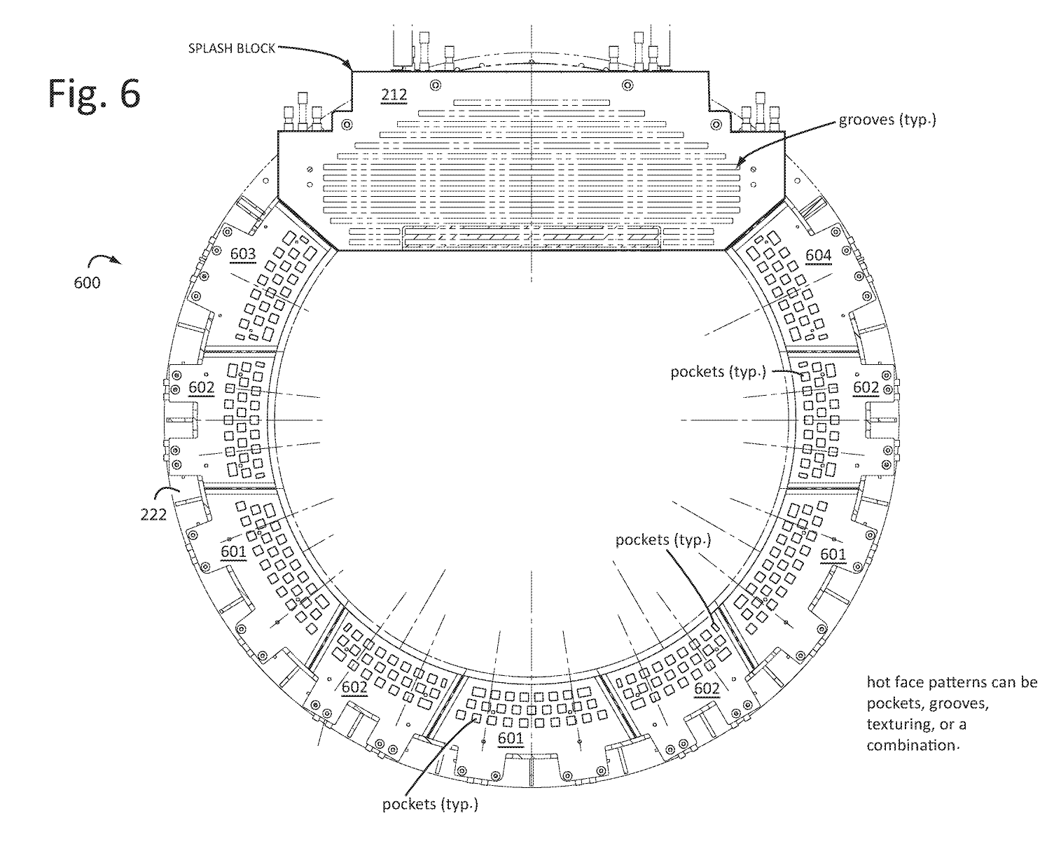

FIGS. 2A-2C represent an improved AUSMELT furnace 200 in an embodiment of the present invention. These furnaces are improved to separate and fully support a refractory brick lining 202 above a bath zone 204 with at least one horizontal cooler lintel shelf 206 fixed externally to a cylindrical steel vessel 208. The lintel shelf 206 is detailed more fully by FIG. 4 with a plan view, e.g., ring row of lintel coolers 400. A second horizontal cooler lintel shelf 210 is also independently fixed externally to the cylindrical steel vessel 208. The second horizontal cooler lintel shelf 210 may include a splash block 212 and is detailed more fully by FIG. 6 with a plan view, e.g., ring row of lintel coolers 600.

This second horizontal cooler lintel shelf 210 need not necessarily include splash block 212. In such case, the second horizontal cooler lintel shelf 210 could be identical to the first horizontal cooler lintel shelf 206 as shown in FIG. 4.

The benefit in bolting both the first and second horizontal cooler lintel shelves 206 and 210 with fasteners to the cylindrical steel vessel 208 is their respective weight loads can be fully redirected into the steel vessel 208, and off the refractory brick in bath zone 204. The cylindrical steel vessel 208 is therefore conscripted to carry all such weight. The more elevated refractory brick lining and horizontal coolers 214 and 216 are allowed to float because they will expand vertically upwards as the refractory material swells over the campaign life.

An external, horizontal steel ring rib 220 is an important structural component of the cylindrical steel vessel 208. Such provides a strong ledge on which machine bolts can be used to secure the individual coolers of the first horizontal cooler lintel shelf 206. FIG. 4 shows lintel shelf 206 in more detail with a plan view.

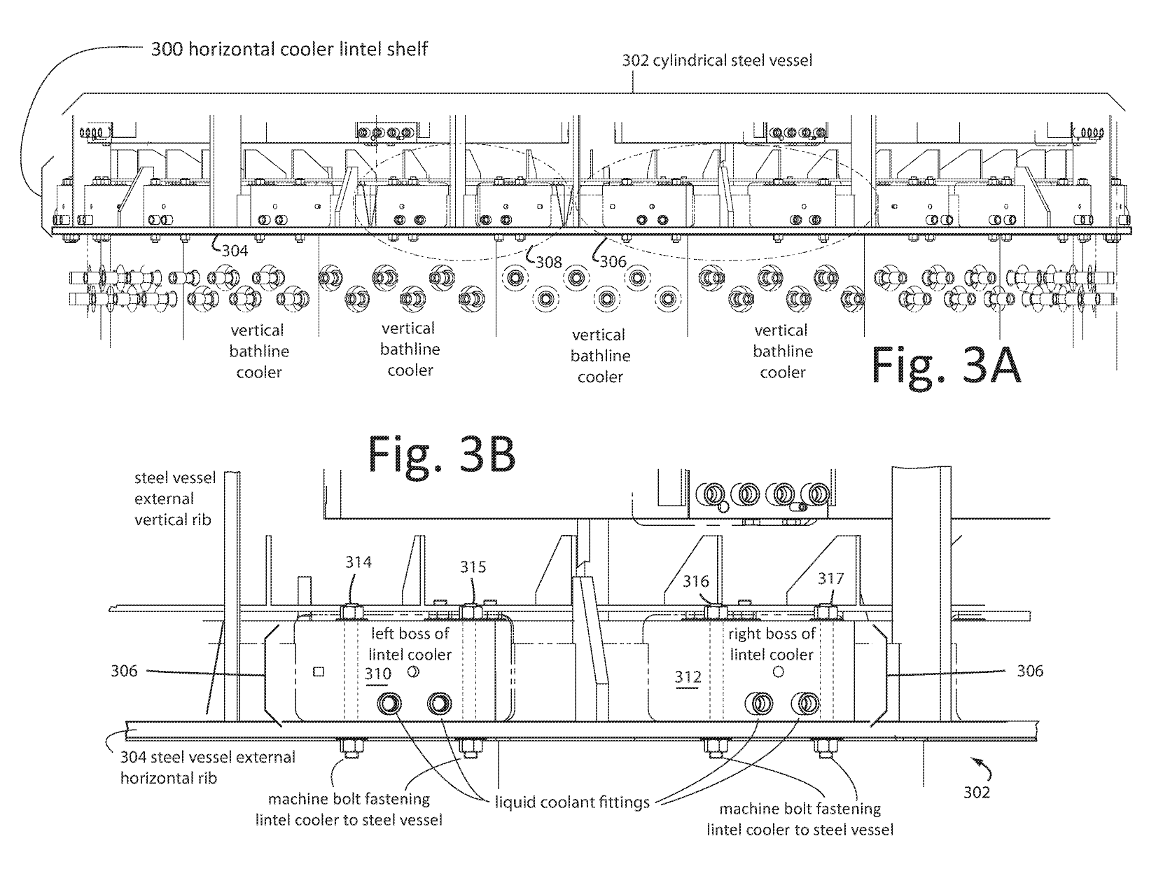

Another external, horizontal steel ring rib 222, higher above, is one more essential structural component of cylindrical steel vessel 208. This too provides a second strong ledge on which machine bolts can be used to secure the individual coolers of the second horizontal cooler lintel shelf 210. FIG. 6 shows lintel shelf 210 in more detail with a plan view. Such mounting details are better illustrated in FIGS. 3A and 3B.

FIGS. 3A and 3B are side view diagrams of a horizontal cooler lintel shelf 300 as it appears from outside a cylindrical steel vessel 302. Such is a vertically orientated metal smelting furnace embodiment of the present invention similar to that of FIGS. 1 and 2A-2C. The cylindrical steel vessel 302 is fabricated from thick plates of steel welded together into a cylinder with a rounded bottom. The cylinder is reinforced with external vertical and horizontal ribs, flanges, and gussets of plate steel. One such reinforcement is a flat steel ring 304 that functions as a horizontal rib to steel vessel 302 and a landing on which to bolt mounting bosses of individual lintel coolers 306 and 308.

The individual lintel coolers 306 and 308 do not float inside steel vessel 302. All the other vertical and horizontal coolers do need to float as the refractory brick they cool swells and expands over the campaign life of the furnace. Such ability to float is hinted at by the many large oversize holes that perforate the steel vessel 302 to accommodate numerous liquid coolant line connections visible in FIGS. 2A-2C and especially 3A.

FIG. 3B, in particular, shows details on how the individual lintel coolers 306 and 308 can be fastened externally to horizontal rib 304. Each lintel cooler 306 and 308 has a left and a ring mounting boss 310 and 312 that protrude through corresponding shell cutouts in steel vessel 302. A set of large machine bolts 314-317 are used here for each lintel cooler 306 and 308. Such can be better understood by viewing the following illustrations.

Sometimes individual lintel coolers 306 and 308 will need to be replaced. It would be a major advantage if such maintenance could be accomplished without also having to remove neighboring coolers or refractory brick to gain access.

FIG. 4 represents how individual lintel coolers in a ring row of lintel coolers 400 can be shaped using individual lintel coolers 401 and 402 to render them independently and individually replaceable. The ring row of lintel coolers 400 of FIG. 4 includes even numbers of lintel coolers 401 and 402.

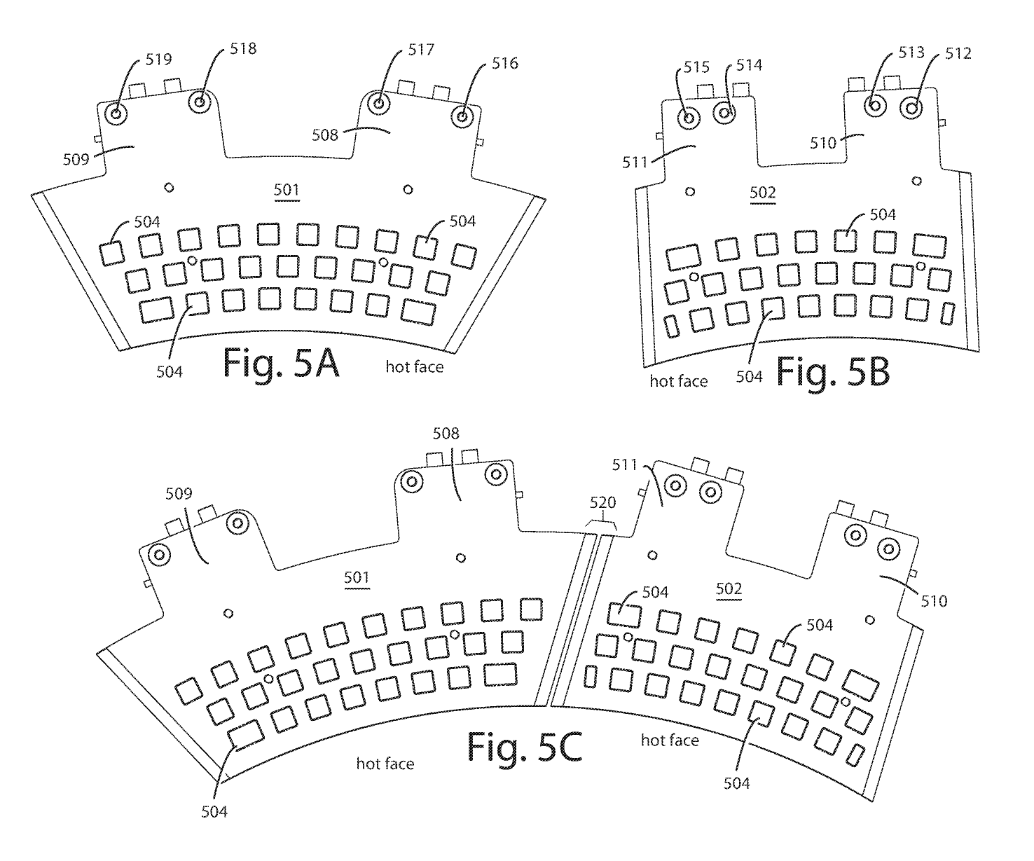

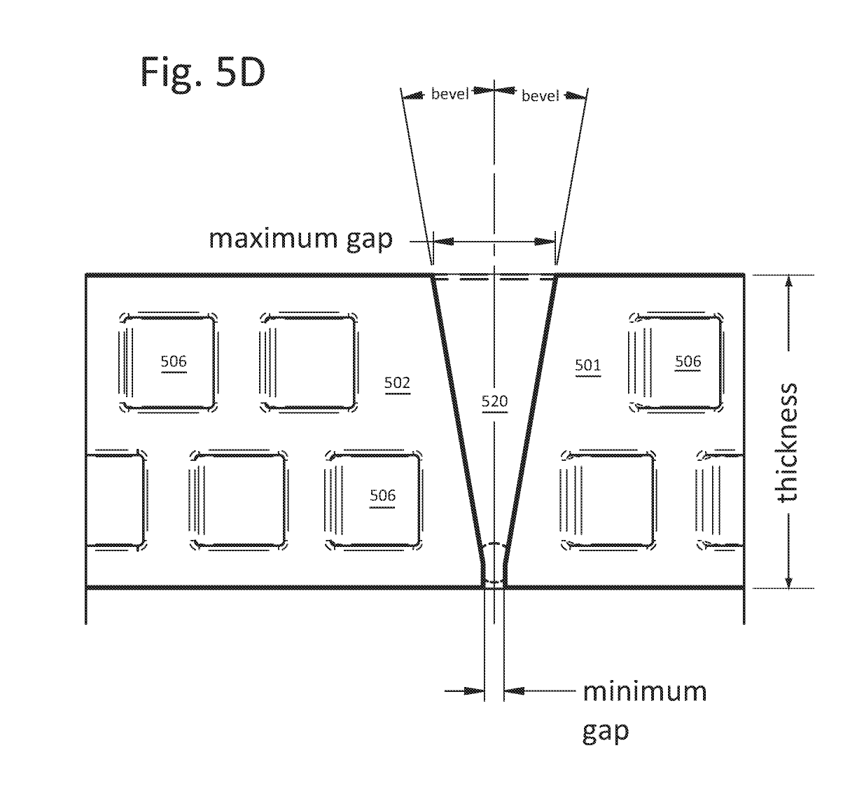

FIGS. 5A-5D represent a typical pair of matching lintel coolers 501 and 502 that are used to make up the ring row of lintel coolers 400 of FIG. 4. Each has a top face populated with textured pockets 504 (typ.) that help refractory castable adhere and seal out gas leaks with a refractory brick lining above. And each has a hot face that is similarly populated with textured pockets 506 (typ.) that help frozen slag and refractory castable adhere.

FIG. 5D represents a V-slot 520 between adjacent lintel coolers 501 and 502 that forms by beveling the sides of each cooler by about 10° . In one commercially viable embodiment of the present invention, the lintel coolers 501 and 502 were 8.0″ thick copper, and V-slot 520 was 0.5″ minimum at the bottom and 3.1″ maximum at the top. During construction or installation, a one inch diameter roll of refractory plastic or RAM is placed in the bottom of V-slot 520. Then chrome alumina castable or RAM is used to backfill V-slot 520 to within 0.12″ of the top face of copper. The remainder is filled in with refractory grain to level.

Each lintel cooler 501 and 502 has one or more mounting bosses 508-511 drilled for machine bolts 512-519.

A V-wedge of castable thus formed at each radial joint locks on top of the coolers, helps support the refractory brick above, and prevents any flow of hot smelting gases between the coolers.

FIG. 6 represents how a splash block 212 (FIG. 2A) is combined with four types of individual lintel coolers in a ring 600. The shapes allow individual lintel coolers to be removed and replaced in maintenance. Here we use lintel coolers 601-604. Lintel coolers 601 and 602 are the same as lintel coolers 401 and 402 of FIG. 4. Additional lintel coolers 603-604 are needed to fit square with splash block 212.

Alternative embodiments may not include this second cantilevered lintel shelf 600, while still others may have a third and a fourth. A steel shelf may also be installed immediately above any horizontal lintel shelf of coolers to provide continuing support of the refractory brick above it should there be a loss of liquid cooling.

A method embodiment of the present invention extends the campaign life of refractory brick in vertically orientated metal smelting or converting furnaces. A vertically orientated metal smelting or converting furnace vessel is partitioned into bath zone and at least one upper zone above the bath zone. The inside of the bath zone of the vessel is lined with a first lining of refractory brick such that its weight is fully supported by a floor at the bottom. A first horizontal ringed lintel shelf of individually and independently replaceable liquid-cooled cooling elements are fastened at a fixed elevation and are mechanically fully supported by their respective attachments on the outside of the furnace vessel above the bath zone. The inside of a first upper zone of the vessel is lined with a second lining of refractory brick such that its weight is mechanically fully supported by a protruding ledge of the first horizontal lintel shelf.

Although particular embodiments of the present invention have been described and illustrated, such is not intended to limit the invention. Modifications and changes will no doubt become apparent to those skilled in the art, and it is intended that the invention only be limited by the scope of the appended claims.

1. A vertically orientated metal smelting or converting furnace wherein at least a portion of its steel shelled vessel is cylindrical, comprising:
at least one horizontal lintel shelf of coolers inside a steel shelled vessel and which each supports and cools a respective upper lining of refractory brick above each in an upper partition that does not contain a liquid melt;
a lower lining of refractory brick inside the steel shelled vessel supported by a floor in a lower partition that contains the liquid melt and that continues above to under the horizontal lintel shelf; and
a seal disposed between, and that accommodates over time, a vertical expansion of the lower lining of refractory brick and the bottom of a corresponding horizontal lintel shelf of coolers above, and that includes at least one of a vertical slip joint and/or a compressible refractory material.

2. The furnace of claim 1, wherein:
the horizontal lintel shelf of coolers comprises individual blocks of liquid cooled elements that are independently installable and replaceable on the inside walls of the vertical cylindrical steel shelled vessel.

3. The furnace of claim 1, wherein:
the lower lining of refractory brick is too thin or otherwise corroded to provide adequate mechanical support of the upper lining of refractory brick without a horizontal lintel shelf of coolers.

4. The furnace of claim 1, wherein the partitioning of the refractory brick into upper and lower partitions minimizes vertical cracking, spalling, and other premature failures due to uneven expansion of the refractory brick.

5. The furnace of claim 1, further comprising:
a splash block installed in one of the horizontal lintel shelf of coolers.

6. The furnace of claim 1, further comprising:
a steel shelf installed immediately above any horizontal lintel shelf of coolers that provides support to refractory brick above it should there be a loss of cooling.

7. A method of extending the campaign life of refractory brick in vertically orientated metal smelting or converting furnaces, comprising:
partitioning a vertically orientated metal smelting or converting furnace vessel into bath zone and at least one upper zone above the bath zone;
lining the inside of the bath zone of the vessel with a first lining of refractory brick such that its weight is fully supported by a floor at the bottom;
fastening at a fixed elevation a first horizontal ringed lintel shelf of individually and independently replaceable liquid-cooled cooling elements that are mechanically fully supported by their respective attachments on the outside of the furnace vessel above the bath zone; and
lining the inside of a first upper zone of the vessel with a second lining of refractory brick such that its weight is mechanically fully supported by a protruding ledge of the first horizontal lintel shelf.

8. The method of claim 7, further comprising:
cooling the first lining of refractory brick in the bath zone of the vessel with vertical bathline coolers pressed to and sandwiched between the inside of the vessel and a cold-face of the first lining of refractory brick.

9. The method of claim 7, further comprising:
cooling the second lining of refractory brick in the bath zone of the vessel with horizontal coolers pressed to the inside of the vessel and interdigitated with the second lining of refractory brick, wherein all of which are disposed above the first horizontal ringed lintel shelf and mechanically fully supported by it.

10. The method of claim 7, further comprising:
sealing between the top of the first lining of refractory brick in the bath zone of the vessel which is subject to upward expansion over campaign life time, and the bottom of the first horizontal ringed lintel shelf, with at least one of a slip joint and a compressible refractory material.
